(19) United States
(12) Patent Application Publication
(10) Pub. No.: US 2006/0134583 A1
(43) Pub. Date: Jun. 22, 2006

(54) Simulation and training sphere for receiving persons

(76) Inventor: Adrian Carlos Gonzalez de Mendoza y Kaeding, Berlin (DE)

Correspondence Address: HAHN LOESER & PARKS, LLP, One GOJO Plaza, Suite 300, AKRON, OH, 44311-1076, US

(21) Appl. No.: 11/323,282

(22) Filed: Dec. 30, 2005

(30) Foreign Application Priority Data
Dec. 22, 2003 (DE) 103 61 417.6
Jul. 2, 2003 (DE) 103 30 994.2
Jul. 2, 2003 (DE) 103 30 992.6
Jul. 2, 2004 (WO) PCT/IB04/05111

(51) Int. Cl. A63B 53/06; G09B 9/08; G09B 19/16; A63B 53/16; A63B 69/36

(52) U.S. Cl. 434/55; 473/247

(57) ABSTRACT

The drive controller of a simulation and training ball is powered by an electromotor on pivoting friction rolls is provided with information about the actual movements of the ball itself and, if necessary, about the movements of a user located inside the ball, thereby making it able to control ball movements taking into account this information. The ball is equipped with force transducers, direction-finding transmitters and receivers, rotational speed sensors and cameras and reference marks, whether alternatively or in combination. In addition, direction-finding transmitters and reference marks can be secured to the user's body. The systems operate individually or allow optional interplay between them.

### TECHNICAL BACKGROUND

This invention relates to stably mounted hollow balls powered by an electromotor on pivoting friction rolls, wherein said hollow balls can be accessed by one or more users, and their drives are controlled via an electronic control unit.

Such balls are able to rotate by 360° around any axis intersecting their central point. They are referred to below as simulation and training balls.

Simulation and training balls are used primarily as flight simulators and entertainment machines, wherein a user generally sits in a kind of cockpit inside the ball, and controls the ball movements using steering wheels, joysticks and the like. (e.g., U.S. Pat. No. 2,344,454). More recent publications describe simulation and training balls that allow the user to move through virtual rooms with the assistance of modern, computer controlled displays. (e.g., EP 0839 559 A1; U.S. Pat. No. 5,980,256; NL 9000722, etc.). Other publications describe devices of the aforementioned type in which the user can move relatively freely on the interior surface of the ball or in scaffolding framework located inside the ball. The movements of individual limbs of a user or his/her entire body are here detected, and used to display the user in the virtual environment, and also to have the user manipulate virtual objects. Various methods are used for this purpose. In one of these methods, references marks are applied to the body of the user in the form of light sources. Several permanently installed photosensors calculate the position of the reference marks in the room based on intensity measurements. One obvious disadvantage to this system is that the positions can only be detected when the signal path between the reference mark and photosensor is free of invisible obstacles, which cannot always be ensured in practice. (e.g., EP 0839 559 A1; U.S. Pat. No. 5,980,256). In addition, non-driven, air-bearing hollow balls whose inner surface can be traversed (GB 2312273; publication EUREKA (GB), April 1998, “VR is having a Ball”). The ball is here moved following the principle of a hamster wheel. A sensor that resembles a computer mouse and abuts the ball surface detects the resultant ball movements. The sensor information and a display unit allow the user to move about freely in a virtual environment. One disadvantage to this system is that a sufficiently large and stable ball has a high intrinsic weight, and hence a high mass inertia. A high level of force is required to set the ball in motion, change the direction of movement and stopping it again, and does not reflect how natural walking feels. In addition, moving about in such a ball poses certain risks, e.g., the user might fall in a rapidly moving ball (washing drum effect).

Devices that offer a similar movement potential are the known gyroscopes. These consist of three circular elements arranged one inside the other, wherein each circular element is mounted so it can rotate around an axis that passes through the midpoint of the circle, and the respective axes of the three circular elements are orthogonal relative to each other, so that a body, preferably a person, located inside the circular element, can be freely moved around its three rotational degrees of freedom in a fixed coordinate system (e.g., U.S. Pat. No. 4,799,667; WO 98/15382, etc.). The human gyroscope is used primarily in sports and recreation. However, it is also used for therapy and training purposes. In the conventional passive variant of a human gyroscope, the shifting weight of a user or outside operator manipulations introduce the rotational impetus.

### DISCLOSURE OF THE INVENTION

Technical Problem

An aspect of this invention is to provide the drive controller of a simulation and training ball powered by an electromotor on pivoting friction rolls with information about the actual movements of the ball itself, as well as about the movements of a user located inside the ball, thereby allowing it to shift the ball movements based upon this information.

One basic aspect of this invention in particular is to describe the necessary system components with which such a ball can be used as a sports device, along with their interaction. Special attention is here paid to enabling sports in virtual environments.

Another problem to be resolved had to do with returning the ball following completion of the movement to a specific initial position that allowed entry and exit from the ball.

Technical Solution

Pivotal importance is here ascribed to the sensor equipment to which this invention primarily relates. Various sensor concepts that ideally enhanced each other were utilized to acquire the necessary information. However, these can also be used independently from each other.

The first concept according to the invention is used to detect the forces produced by the movements of the user and ball. To this end, the ball scaffolding that carries the drive units and ball itself is placed on a sub-frame, which is rigidly secured or even anchored to the floor. The ball scaffolding is connected with the frame through an arrangement of structural components that are able to measure the dynamic forces acting on them in all three spatial dimensions. The drives then move the ball based on the ascertained forces and directions of force.

The advantage to using such force transducers is that they directly acquire the dynamic forces that actually arise. These are precisely the forces that set a passive system like a human gyroscope or Rhoenrad in motion.

In addition, overload situations and system disturbances can be detected or avoided by means of force transducers.

Assuming a high enough resolution, the data acquired by the force transducers are sufficient to control the ball. However, oscillations, imbalances in the ball sheath and rocking motions of the drives provide for disruptive influences given faster movements of the ball sheath. While the latter can in part be detected as fault signals and differentiated from the useful signal using appropriately programmed software, it must be expected that the sensitivity with which the controller reacts to the signals delivered by the force transducer will have to be diminished.

Another problem associated with force transducers that work with strain gauges is that the measuring range can break down into a maximum 15000 measuring increments. Based on the theoretically possible peak values with the ball in full motion, a measuring range of ±7500 N may make sense. In this case, a force under 1 N can no longer be ascertained with absolute certainty, even under ideal conditions. Under real conditions, and in particular with the ball in full motion, this resolution can be diminished to even a much greater extent. This means that only those movements of the user lying above the resolution limit are detected.

The invention incorporates an embodiment for a suitable force transducer and its integration into the ball scaffolding. This portion of the invention is described in greater detail in the claims, drawings and explanations to the drawings.

In a second concept according to the invention, runtime measurements of electromagnetic waves are used to detect positional changes of direction-finding transmitters. These direction-finding transmitters are used in an advantageous embodiment to determine the position and orientation of the balls. They are secured to fixed positions in the ball sheath. The receivers used for runtime measurements are here arranged on fixed points that are known to the controller and spaced as far apart as possible.

This arrangement can also be reversed, so that the receivers are located inside the ball, and the transmitters in the ball sheath. This arrangement offers special advantages for an embodiment of the invention described further on.

In this case, at least three transmitters are required for precise position determination in the room; however, each additional transmitter increases measuring accuracy and reduces the effect of disturbance factors.

The mentioned determination of ball position and orientation yields an additional tool for increasing measuring sensitivity. This allows the controller to detect and consider imbalances and deviations from ideal spherical shape, which generate undesired dynamic forces with the ball in motion.

In addition, the advantage to determining the ball position and orientation is that the ball can be automatically returned to its initial position.

In another advantageous embodiment, additional direction-finding transmitters (25) are secured to fixed positions on the user's body. This arrangement makes it possible to acquire the actual movements (and not just the dynamic forces resulting from these movements) of the user in the ball via the controller. The same receivers used for determining ball position can here be used to record the signals from these direction-finding transmitters.

In order to precisely determine the user movements, a direction-finding transmitter is preferably situated to the right and left of the skull, on each shoulder, on both elbows, on both wrists, on the back of both hands, on both hips, on both knee joints, on both ankles and on both insteps. The direction-finding signal of each transmitter has a unique modulated code that makes it unmistakable for the controller and clearly points to one of the above positions on the body. If user movements are detected with direction-finding transmitters, it makes sense to arrange the receivers in the ball sheath, since the metallic structures in the ball sheath cannot get between the direction-finding transmitters on the body of the user and the receivers, so that a higher quality can be expected.

The movements of the individual transmitters are determined in real time and relayed to a computer. This computer represents the position of each individual direction-finding transmitter as a point in a three-dimensional coordinate system. Each of these points is here assigned a measuring value that should correspond to the actually moved mass as closely as possible. The computer derives force vectors from the movement of these mass points in the room based on the laws of mass inertia. The sum of individual forces ascertained in this way yields the overall force theoretically acting on the ball and its effective direction.

In order to fine tune the system to the special body mass distribution of each user, the user performs a predetermined sequence of movements prior to initial use with the ball motionless, which the system calibrates to this use. The result of this calibration can be store, so that recalibration need only take place if the body mass distribution has distinctly changed. It is also possible to perform this calibration outside the ball on a measuring bench specially equipped for this purpose, or to even forego a calibration completely and work with experimental values. For example, it is theoretically possible to control a ball without force transducers based solely on direction-finding transmitter signals.

However, if both sensor concepts are unified in a single device, they can enhance each other. Coupling the direction-finding transmitter-based mass model with the values provided by the force transducer makes it possible to interpolate between two increments, and hereby greatly increase the sensitivity.

In another advantageous embodiment, the two sensor systems are tailored to each other in such a way that errors of one system are recognized by the other and offset. For example, if a high dynamic force is encountered but not associated with a corresponding strong movement of the user, it either remains ignored or is recognized as a system disturbance, causing the ball to be stopped. If the direction-finding transmitters provide ambiguous information, the ball can still be controlled via the force transducers.

The user movements detected via the direction-finding transmitters can also be sued to detect falls, and hence enhance user safety and stop the ball in this case.

One great advantage of determining user movements with direction-finding transmitters is that a body can be made visible in a virtual space based on the supplied data, mimicking the actual movements of the user. If the user moves through a virtual space, other visitors to this room can see him/her. This makes it possible to pursue sports activities in a virtual space over long distances with opponents fully visible to the user. The movement sequences of the user can also be saved, to be subsequently viewed and analyzed.

If the user is wearing data goggles (HMD) in the ball, this system allows him to look at himself, despite the goggles. Therefore, he can control his own movements visually as well. In conjunction with data gloves, even the manipulation of virtual objects becomes possible.

In another advantageous embodiment, the system has reference direction-finding transmitters located at a fixed and known distance from the receivers. These are used to reference the system and differentiate between useful signals and fault signals.

In another advantageous embodiment, rotational speed sensors and inclination angle sensors are secured in the ball sheath and to the user. These are used to verify or enhance the information supplied by the direction-finding transmitters.

In another advantageous embodiment, three rotational speed sensors (one per spatial axis) completely replace the direction-finding transmitters for determining ball position. However, the precondition for this is that the latter be subject to a negligibly small zero point drift. If only rotational speed sensors are used in the ball sheath, it must also be possible to reference the system. Automatic referencing here takes place according to the invention via at least one reference mark that is secured to the ball sheath in a location known to the controller, and detected by a camera hooked up to an image processor.

If an application or the ball position requires no seamless data stream and the center point of the ball remains constant within narrow limits relative to the surrounding scaffolding, the ball position and orientation can be completely determined via reference marks on the ball sheath.

In a preferred embodiment of the invention, such a system works based on differentiable reference marks distributed uniformly on the ball sheath. The individual reference marks are designed in such a way as to provide precise information as to their respective position, and as to the orientation of the ball sheath. One section of the ball sheath is here photographed in regular time intervals by a fixed (high-speed) video camera arranged in the ball scaffolding. The photographs are analyzed by an electronic image processing system. The reference marks in the image sections are detected, and a conclusion as to the position and orientation of the ball sheath is made based on their position and orientation in the image. This system offers advantages in cases where direction-finding transmitters need not be used for other tasks anyway, and where drive movements in all operating situations point sufficiently accurately to the ball position, and only the zero point drift resulting from drive slip must be compensated for in regular time intervals. Another advantage is that no electrical components must be situated inside the ball for this system, since providing a reliable power supply for them always poses a problem.

In another advantageous embodiment, special reference marks need not be provided on the ball surface, as long as the ball surface bears a sufficient number of uniformly distributed and visually distinguishable features. These features can include the joints of the shell elements comprising the ball. This ball position acquisition system proceeds from a known initial position of the ball. If the ball is now moved in a specific direction via the drive, a virtual model of the ball having the same visually distinguishable features as the actual ball is also moved based on the positional change intended by the controller. A fixed (high-speed) camera situated in the ball scaffolding photographs a section of the ball sheath in short time intervals. A virtual camera that “photographs” the same ball sheath segment at the same moment in time on the virtual ball model now provides an image for comparison. If these two images are compared with each other using suitable software, the slip-induced deviation of the actual position from the desired position can be determined, for example, and the controller can be referenced to the new actual position. Repeating this process in sufficiently short intervals makes it possible to obtain reliable information about the current ball position at any time, so that the position can be determined within an accuracy of a few angular minutes given the proper configuration. The only hardware required for this purpose is a powerful computer and a camera.

In like manner, the movements of a user in the ball can also be detected and utilized to control the ball movements. To this end, the user in the ball is observed by at least three, but even better six or more synchronously recording cameras, which completely film him from the most varied visual perspectives possible. These cameras can be located outside the ball, and record the user through the transparent sheath of the ball, or can be situated inside the ball sheath itself, directly photographing the user without any visual impediment whatsoever. Each of the cameras here has its own computer-assisted image processing system. The images recorded in rapid succession (preferably 30 or more per second) are analyzed by the image processing system, and subjected to template matching. Template matching is here based on a database accessible to the image processing system with digital images of different body postures, in turn recorded from the most varied of visual perspectives. If the image processing system is able to assign a specific template to a photograph, that template is released and relayed to a central computer to which all other cameras are connected as well. If at least two image processing systems hooked up to the cameras provide the central computer with a template selection that relates to the same point in time the recording was made and involves the same or highly similar body posture, the computer may already have enough information to approximately interpolate from this the posture and position of the user in the ball in three dimensions. To ensure greater reliability for the findings, the result of the respective up-to-date photographs can be compared with the preceding ones. The current determined body posture and position is only recognized as valid if it could have theoretically emanated from the preceding situation in the intervening period. The three-dimensional model of the user body in the computer based on experimental values or actual measurements (e.g., via the aforementioned force transducers) is assigned an overall mass, and proceeding from that, a mass distribution based on experimental values. A series of chronological photographs can be used to acquire movements of the user in the ball, and the aforementioned mass model makes it possible to obtain data based on the dynamic forces of the moved masses, with which the ball movements can be controlled. However, not just the theoretical dynamic forces can be drawn upon to control the ball movements. Alternatively or additionally, specific body postures or movement sequences can be interpreted as gesture-based commands or signals that initiate a behavioral change on the part of the drive controller. Such commands can include Start, Stop, Back to Initial Position, Faster, Slower, etc. The advantage here is that additional input devices need not be used under certain conditions.

The significant advantage of this system is that the computer can theoretically determine a model for the user body that is precise down to the fingertips without the user having to wear special marks or clothing on his body for this purpose (even though special marks or clothing can assist in the recognition process). One desirable side effect is that the user body is not only made visible in virtual spaces in this way, but he can additionally manipulate virtual objects as well.

The disadvantages to this system include the very high requirements placed on the hardware and software. In addition, the system may reach its limits when the object is to determine the movements of several users.

### BRIEF DESCRIPTION OF DRAWINGS

The figures show:

FIG. 1: A simulation and training ball with force transducers corresponding to the preamble of claim 1.

FIG. 2: Force transducers in scaffolding (without drive unit).

FIG. 3: Force transducer, cut.

FIG. 4: Deformation of force transducers given exposure to vertical force.

FIG. 5: Deformation of force transducers given exposure to horizontal force.

FIG. 6: Interaction of three force transducers in scaffolding.

FIG. 7: Position determination of ball and user with direction-finding transmitters—receivers outside.

FIG. 8: Position determination of ball and user with direction-finding transmitters—receivers inside.

FIG. 9: Position determination of ball with reference marks.

FIG. 10: Visual position determination of ball sheath.

FIG. 11: Comparison of desired and actual position.

FIG. 12: Visual determination of body posture and body position of user.

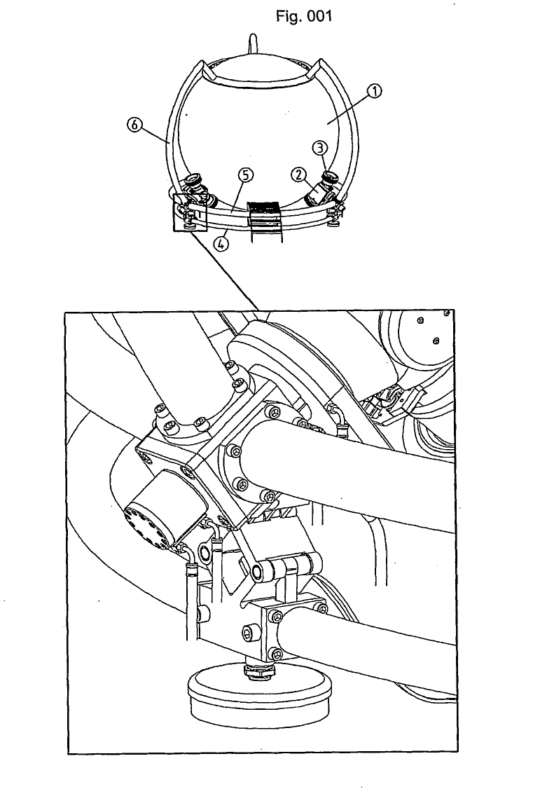

The top part of FIG. 1 shows a simulation and training ball corresponding to the preamble of claim 1. Highlighted therein: the ball sheath 1, the pivoting drive units 2 with the friction rolls 3, with which the ball sheath 1 is moved, and on which it simultaneously sits, and the scaffolding 6 encompassing the ball sheath 1. According to the invention, force transducers are arranged between the bottom scaffolding ring 5 that carries the drive units 2 and the base ring 4 sitting up on the sub-floor. The lower portion of the drawing shows a magnified view of this arrangement.

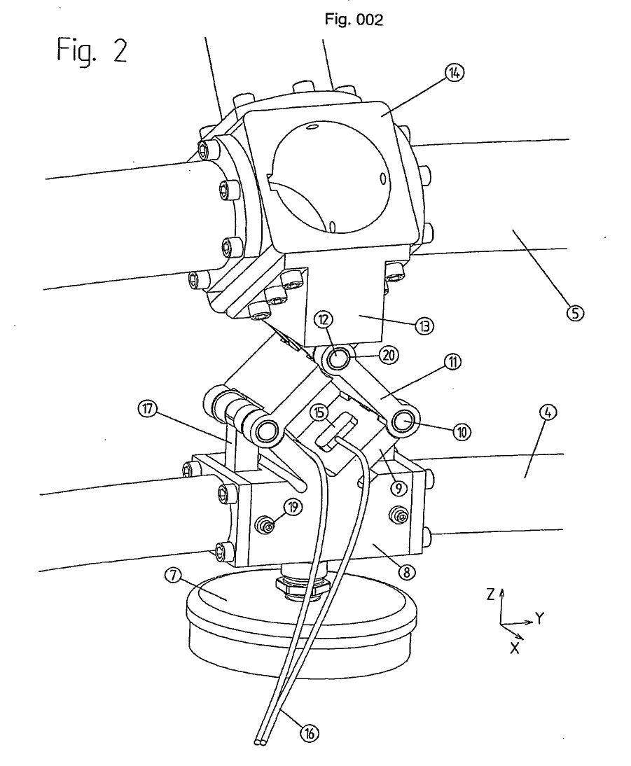

FIG. 2 shows the same detail from another perspective. The drive unit 2 is here removed. The components of the depicted force transducers are here situated between the base 7 and the receiving block 14 carrying the drive unit 2. The force transducer consists specifically of the base block 8, which supports the two V-shaped, upwardly projecting elastic bending legs 9. Each bending leg 9 accommodates a strain gauge 15 connected by a signal line 16 with the measuring amplifier and controller. If the connecting block 13 is now exposed to forces in the Y or Z direction, the latter are relayed via the axis 12 to the transmitting legs 11, which themselves transmit them via the axis 10 to the bending legs 9. The introduced forces deform the bending legs 9. The degree of deformation is determined based on the change in resistance of the strain gauge 15. The introduced forces can be derived from this change in resistance. To avoid placing too much of a load on the strain gauge 15, the path of the ending legs 9 is limited by an adjustable overload protector 17.

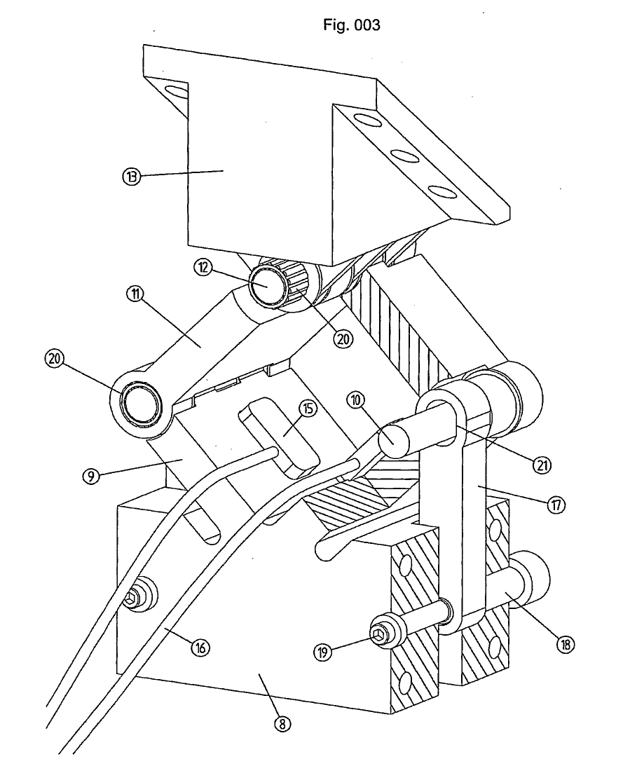

FIG. 3 shows a section through one force transducer according to the invention. As opposed to FIG. 2, the mode of operation of the overload protector 17 here becomes visible. The upper portion of the overload protector 17 has a longitudinal hole, through which the axis 10 is guided. As a result, the bending leg 9 can only deform within the limits prescribed by the longitudinal hole 21. The overload protector 17 can be adjusted using the eccentric shaft 18. The adjustment can be made permanent with the locking screw 19. In addition, the section shows that the axial connections are mounted on roller bearings 20. This decreases the stick-slip effect more frequently encountered under a high load, thereby increasing the measuring accuracy.

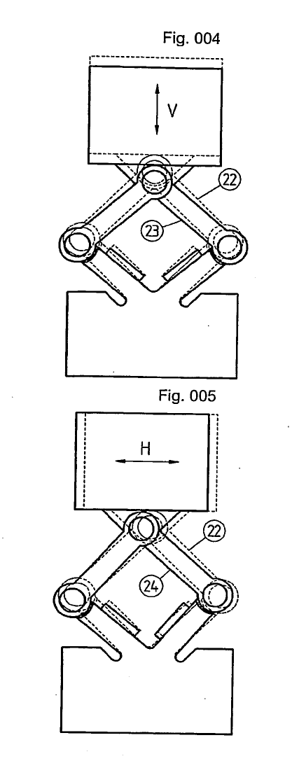

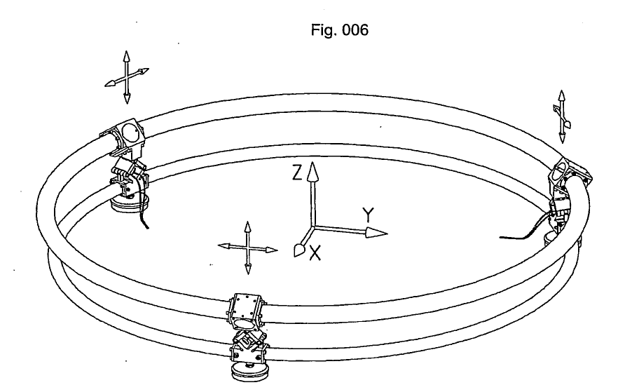

FIG. 4 and 5 show the deformations that arise on the force transducers given vertically 23 and horizontally 24 introduced forces. The hatched contour 22 shows the undeformed force transducer. This depiction illustrates just how the force transducer can differentiate between vertical and horizontal forces: Vertical forces lead to an equal expansion of the strain gauge 15. Horizontal forces lead to an expansion of the one and a reduction of the other strain gauge. In other words, the absolute values of both force transducers increase uniformly given a vertical dynamic force. If the absolute values of both force transducers change irregularly, a horizontal dynamic force is present.

FIG. 6 shows an example for the distribution of three force transducers in the ball scaffolding. As evident from this distribution, the force transducer according to the invention can be used to recognize rotational impulses in all three spatial axes.

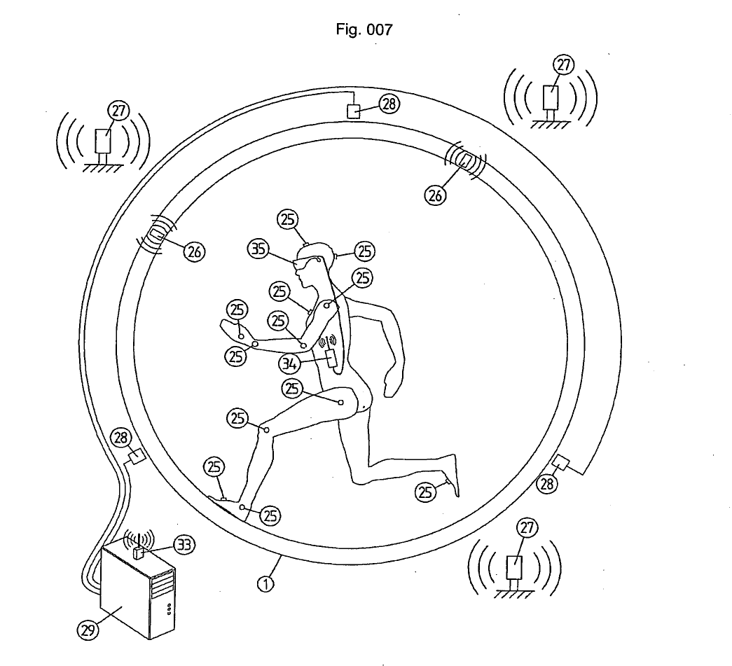

FIG. 7 shows an embodiment of the invention with direction-finding transmitters and receivers for determining the position of user and ball. Receivers 28 situated inside the ball scaffolding measure the runtimes of the signals from the direction-finding transmitters in the ball sheath 26, and from the direction-finding transmitters on the user's body 25, and relay them to a computer 29, which uses this information to derive the position and orientation of the ball and body posture of the user. This data is relayed as control signals to the drive controller and the computer that updates the virtual environment. The updated image is passed on via the transmitter 33 to the receiver 34 worn by the user, and shown on the screen of the head-mounted display 35. Reference direction-finding transmitters 27 immovably installed in the ball scaffolding help to distinguish useful signals from (reflected) fault signals.

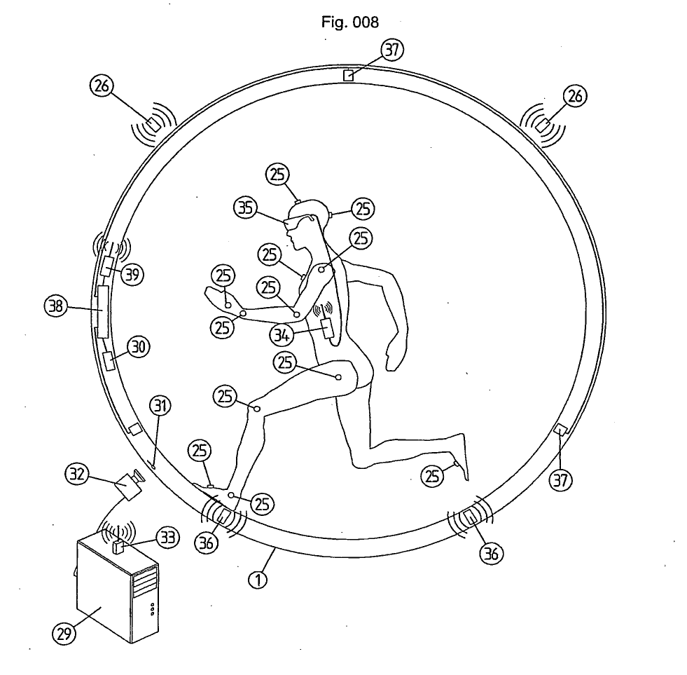

FIG. 8 shows another embodiment of the invention with direction-finding transmitters and receivers for determining the position of the user and ball. Receivers 37 arranged in the ball sheath 1 measure the runtimes of the signals from the direction-finding transmitters in the ball scaffolding 26, and from the direction-finding transmitters on the user's body 25, and relay them to computer 38 located inside the ball sheath 1, which derives the position and orientation of the ball and body posture of the user from this. Rotational speed sensors 30 also attached in the ball sheath 1 are used to verify the determined ball sheath. The determined position data are sent to an external computer by means of the transceiver 39. This information is relayed in the form of control signals to the drive controller and the computer that updates the virtual environment. The updated image is passed on via the transmitter 33 to the receiver 34 worn by the user and displayed on the HMD. Reference direction-finding transmitters 36 immovably installed in the ball sheath help to distinguish useful signals from (reflected) fault signals. A reference mark 31 on the ball sheath 1 is used to reference the zero-point, and recorded by a camera 32 hooked up to an image processing system.

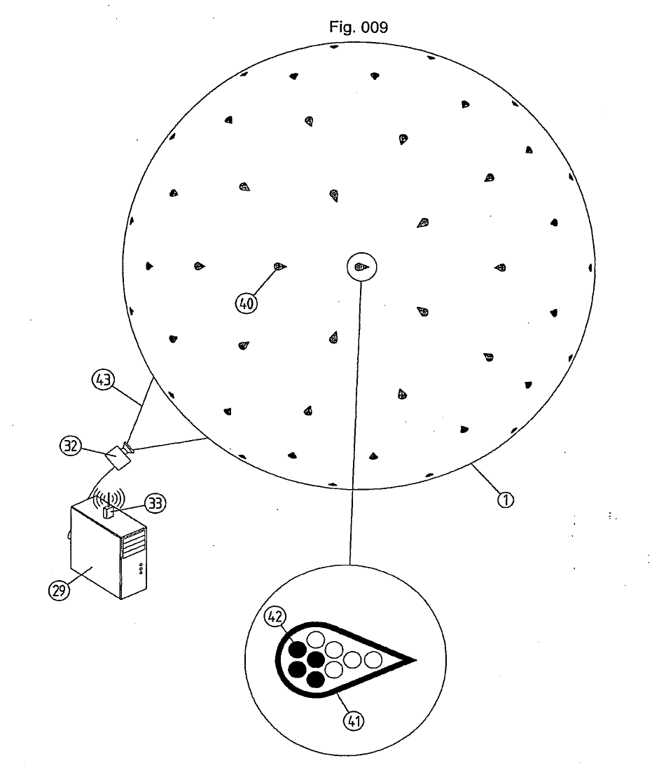

FIG. 9 shows an embodiment of the invention in which the ball position and orientation is determined by means of several reference marks 40 that are uniformly distributed on the ball sheath and can be distinguished from each other. The individual reference marks 40 are configured in such a way as to provide exact information about their respective position and the orientation of the ball sheath 1. The magnified section in the bottom of the figure shows an example of such a mark. The edging 41 resembles an arrow, thereby providing information about the orientation. The interior contains nine fields 42, which can be filled or blank, as desired. As a result, exhausting all possibilities yields a maximum of 512 differentiable marks. The controller knows the position and orientation of each mark, and can therefore draw conclusions as to the position and orientation of the ball. The reference marks 40 should cover the ball surface densely enough that at least one mark is located in the image section 43 of the video camera 32 in each ball position. The photographs are relayed to the computer 29 and evaluated by image processing software.

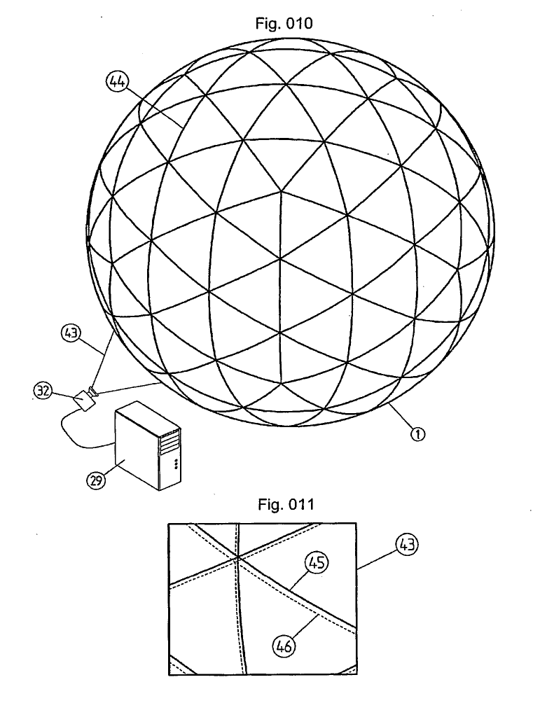

FIG. 10 shows an embodiment of the invention corresponding to claim 30. It shows the visually distinguishable features 44 of the ball sheath, wherein the seams of the shell components are depicted here. A stationary camera 32 records a section of the ball surface in regular time intervals to precisely determine the position of the ball sheath 1. The computer 29 to which the camera 32 relays its images knows the exact position and orientation of the camera, size and shape of the image section 43, along with the precise time at which the camera takes each picture.

FIG. 11 shows an example of an image 45 provided by the camera 32 on FIG. 11, which represents the actual position, and of the image 46 derived from the virtual model, which represents the desired position. By comparing image information, software installed on the computer 29 can determine the deviation between the actual and desired position, and prompt the drive controller to harmonize the actual and set position.

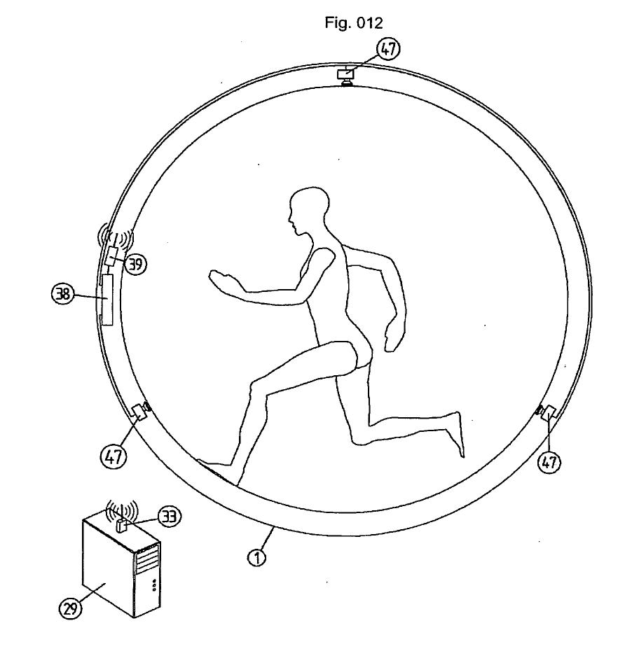

FIG. 12 shows an embodiment of the invention corresponding to claim 31. It shows the cameras 47 situated within the ball sheath, which photograph the user from different perspectives. In this example, the image information from all cameras 47 are relayed to a computer 38 located inside the ball, which compresses the obtained image information and relays it via a transceiver 39 to an external computer 29 that also has a transceiver 33 for receiving the data. This computer 29 evaluates the image information, and generates commands from the recognized user movements that control the ball movements.

The Best Way to Utilize the Invention

The best way to implement the invention depends on the specific intended application of the simulation and training ball. If the ball is not directly controlled by user movements, but is program-controlled or manipulated with a joystick, trackball or similar input device, only the described possible ways of determining the position of the ball are required, along with, if necessary, the force transducers for detecting overload situations and system disturbances. The various described ways for ball position determination—visually using reference marks or feature detection, as well as through runtime measurements using radio technology—can be utilized individually, but also combined as desired to increase redundancy. The ideal selection for the specific case at hand will conceivably depend on numerous factors, and will not be elaborated upon here.

By contrast, if the user movements are acquired, and the obtained data are used to control the drives, it would always make sense to draw upon force transducers, at least as a supplementary means for analyzing the user movements. While the dynamic forces can also be approximately determined by the described visual or direction-finding transmitter-based systems, these systems have to contend with certain difficulties. In the case of a user walking in the ball, for example, it is hard to teach a visual or direction-finding transmitter-based system the precise moment at which the foot of the user contacts the ball sheath, and in the process whether he has good traction on the interior wall of the ball, or is slipping. On the other hand, the visual or direction-finding transmitter-based systems are impervious to disturbing influences, such as vibrations, outward forces or dynamic forces owing to the ball motion itself. Since the error sources of the one system can be offset by the respective other system, combining both systems is the best way to acquire user movements for purposes of drive control.

We claim:

1. A simulation and training ball for accommodating persons comprising an electromotor, pivoting friction roll drive and an electronic drive controller, wherein the weight of the ball and drives is centered on at least three points, of which at least two points are provided with force transducers, which are able to detect shifts in the weight of a user in the ball.

2. The simulation and training ball according to claim 1, wherein at least two of the three points are provided with force transducers that detect the forces in a vertical direction, and at least one point is additionally provided with a horizontal force transducer, which acquires rotational movements with a rotational axis perpendicular to the plane defined by the three points.

3. The simulation and training ball according to claim 2, wherein the measuring device under at least one of the support points consists of two force transducers arranged in such a way that they can measure and differentiate both force components.

4. The simulation and training ball according to claim 1, wherein the force tranducers are based on strain gauges.

5. The simulation and training ball according to claim 4, wherein the strain gauges are protected against overloads by path limiters.

6. The simulation and training ball according to claim 4, wherein the force measuring device is comprised of a base platform from which two bending legs securely fastened thereto and each provided with one strain gauge project upwardly in a V-shaped configuration, wherein the top end of the two bending legs bears two transmitting legs that form a roof relative to each other, and are joined with an axis in the gable of the roof, so that the bending legs and transmitting legs together form a lozenge on which the overlying structure conveys all arising forces over the axis located in the roof gable to the force measuring device, so that a vertically introduced force in both strain gauges yields measuring value changes with the same sign, and laterally acting forces lead to measuring value changes with unequal signs.

7. The simulation and training ball according to claim 1, wherein the weight shifts detected by the force transducers are utilized to control the ball movements.

8. The simulation and training ball according to claim 1, wherein the information about the shifts in weight of the user acquired by the force transducers can be stored and evaluated by a computer.

9. The simulation and training ball according to claim 8, wherein the is computer has an output interface via which the stored information, can be output, and thereby made accessible to the user.

10. The simulation and training ball according to claim 9, wherein the computer has an Internet connection, and makes user-specific data accessible via the Internet.

11. The simulation and training ball according the claim 8, wherein the computer has a user identification system that is able to store user-specific data, and load or output these data on request.

12. The simulation and training ball according to claim 1, wherein a kinematic model of the moved components is filed in the drive controller, thereby allowing the drive controller to filter out excursions of the force transducer owing to moments of inertia.

13. The simulation and training ball according to claim 12, wherein the kinematic model is designed as a self-learning system, so that changes in the system can be determined and considered after a reference run.

14. A simulation and training ball for accommodating persons comprising an electromotor, a pivoting friction roll drive and an electronic drive controller, additionally comprising a system for determining the position of moving components in the ball, which generates electromagnetic waves based on an electronic comparison of runtime measurements, and consists of at least one direction-finding transmitter and at least two receivers, wherein the direction-finding transmitter is accommodated in the movable part of the device, and the receivers are accommodated in the stationary part of the device, or vice versa.

15. The simulation and training ball according to claim 14, wherein one or more direction-finding transmitters are secured to the ball sheath, so that the ball position can be determined.

16. The simulation and training ball according to claim 15, wherein when several direction-finding transmitters are used, the signals of these direction-finding transmitters are made differentiable for the receiver, wherein this is accomplished with varying transmission frequencies, or using an amplitude or frequency modulation of a co-transmitted codes.

17. The simulation and training ball according to claim 14, wherein the user inside is fitted with direction-finding transmitters that are attached to his body at points suitable for position determination.

18. The simulation and training ball according to claim 17, wherein these direction-finding transmitters are secured at least to the head, shoulders, elbows, wrists, hips, knees, ankles and feet, thereby making it possible to largely determine the position of the user's body at any time.

19. The simulation and training ball according to claim 15, wherein a rotational speed sensor immovably installed in the ball sheath is additionally used for determining the ball position.

20. The simulation and training ball according to claim 19, wherein the measuring values output by the rotational speed sensor are digitally coded and modulated to a direction-finding transmitter signal, eliminating the need for an additional transceiver unit for the rotational speed measuring values.

21. The simulation and training ball according to claim 14, wherein immovably installed reference direction-finding transmitters are located outside the moving part of the device, wherein their precise position in the room is known to the electronic evaluators, and they are suitable to reduce the influence of disturbance factors.

22. The simulation and training ball according to claim 21, wherein the ball surface has at least one reference mark that is used to reference the direction-finding transmitters and/or rotational speed sensors that act to determine the position of the ball and has a position known to the electronic evaluators, wherein the reference mark is configured in such a way that it can also be used to determine the angular position of the ball around the axis that is formed by the center of the ball and the reference mark on the ball surface.

23. The simulation and training ball according to claim 22, wherein the position and orientation of this reference mark can be acquired by an automatic image processing system and made available to the electronic evaluators.

24. The simulation and training ball according to claim 22, wherein the information about the position and movement of the ball and user obtained in this way can influence the drive controller via electronic coupling.

25. The simulation and training ball according to claim 14, wherein the position data of the direction-finding transmitters located on the body of the user that was derived from the runtime measurements is used to generate a virtual body model of the user in a computer, so that the actual movements of the user in the ball can thereby be interpreted and stored.

26. A simulation and training ball for accommodating persons comprising an electromotor, pivoting friction roll drive and an electronic drive controller, additionally comprising a system for determining the position of the ball sheath that works based on a reference mark situated on the moving ball sheath, wherein the reference mark can be positionally referenced to a structural component fixed in place outside the ball, and the ascertained positional reference can be imparted to the drive controller.

27. The simulation and training ball according to claim 26, wherein the structural component is an optical sensor.

28. The simulation and training ball according to claim 26, wherein a plurality of these reference marks are arranged on the surface of the ball.

29. The simulation and training ball according to claim 28, wherein each reference mark is configured in such a way as to provide exact information about its respective position and/or the orientation of the ball sheath.

30. A simulation and training ball for accommodating persons comprising an electromotor, a pivoting friction roll drive and an electronic drive controller, wherein the ball sheath has visually differentiable features, and that at least one camera that has a precisely known position and orientation and image section and is oriented toward the ball sheath photographs these differentiable features, and relays the recorded image to a computer, as well as software running on this computer, which contains a virtual model of the ball surface and differentiable features thereon, moves this model based on the ball movements intended by the drive controller, initiates a comparison between the image provided by the camera and an identical image section of the virtual model, and can arrive at a conclusion as to the actual position of the ball sheath based on this comparison, and that this information is used to control the ball movements.

31. A simulation and training ball for accommodating persons comprising an electromotor, a pivoting friction roll drive and an electronic drive controller, wherein the user in the ball is photographed by at least three cameras in tight periodic intervals from various perspectives, wherein all cameras always take a picture at the same point in time, and that the image group belonging to each point in time a picture is taken is relayed for analysis to a computer having software that can generate a three-dimensional virtual image of the user body by comparing the image information items to each other, and if necessary, additionally comparing templates with digitized images or a virtual model of a user body, and have the information about user posture and position in the ball obtained in this way interpreted by this software as control commands and relayed to the drive controller, so that the user can influence the ball movements with his own movements in this way.
